(19) United States
(12) Patent Application Publication
(10) Pub. No.: US 2013/0332545 A1
(43) Pub. Date: Dec. 12, 2013

(54) COLLABORATIVE MODERATION OF SOCIAL MEDIA POSTS

(71) Applicants: Guy W. Primus, Los Angeles, CA (US); Raymond E. Donnelly, III, Washington, DC (US); David L. Marra, JR., Annandale, VA (US)

(72) Inventors: Guy W. Primus, Los Angeles, CA (US); Raymond E. Donnelly, III, Washington, DC (US); David L. Marra, JR., Annandale, VA (US)

(21) Appl. No.: 13/835,456

(22) Filed: Mar. 15, 2013

Related U.S. Application Data
(60) Provisional application No. 61/658,604, filed on Jun. 12, 2012.

(51) Int. Cl. H04L 12/58

(52) U.S. Cl. CPC H04L 51/32
USPC 709/206

(57) ABSTRACT

A mobile and web-enabled method provides oversight used to control posts and tweets to social media sites such as TWITTER, FACEBOOK and TUMBLR. Using a collaborative moderation approach which enables a user selected jury of friends, parents or colleagues to view, recommend edits to, and ultimately approve or deny the posts, the method is used to monitor, manage and prevent inappropriate content or incorrect posts before they go live. The collaborative moderation approach utilizes different rules established by the user that determine when and if a post will be approved. The method allows any person, organization or business to proactively manage the online reputation and control the brand of the user before damage is caused by an offending social media post. In addition, a third party can be designated to initiate posts on behalf of the user.

This application claims the benefit of provisional patent application No. 61/658,604 filed Jun. 12, 2012.

### BACKGROUND OF THE INVENTION

Social media platforms such as Twitter and Facebook create a perfect marketplace for the exchange of thoughts, ideas and perspectives of celebrities, politicians, athletes and other “famous” individuals. Increasingly, these platforms create “unbridled access”. Users of these platforms not only engage and interact in real-time with the general population, but can, by way of statistics, re-tweets, and other methods, gauge their personal brands as well their impact on society in general.

Unfortunately, there is considerable risk to transmission of social commentary without sufficient thought or appreciation for the consequences of such transmissions. When perspectives are shared too quickly and too easily, taboos and misstatements tend to make headlines. Oftentimes, meaning is taken out of context or misinterpreted. In addition, misinformation is often transmitted without the proper cross-checking of its accuracy. This can lead to repercussions causing the user embarrassment or loss of stature in the eyes of the public.

While the social media missteps of celebrities and other high-profile individuals are more visible because of their large number of followers and others who are interested in them in general, everyday people are not immune to the negative effects of social media storms of their own creation. A recent survey by Schools.com concluded that 82% of colleges and universities use social media in their recruiting process and 38% of colleges reported that students' online profiles have had a negative impact on their admissions chances. The present invention was developed in order to provide a way to monitor social commentary and pre-approve, in real-time, commentary that is less likely to cross social norms or conflict with what is considered acceptable.

### BRIEF DESCRIPTION OF THE PRIOR ART

Individuals want social media to have a positive impact on their online reputation and personal brand. They want to ensure that their posts are interpreted the way that they mean for them to be, and they want each individual post to be accretive to their individual brands. It stands to reason that individuals regret when posts that they make to social media have a negative impact on their reputations and brands, either due to misinterpretation or a lack of judgment on behalf of the individual.

Experience indicates that stakeholders in an individual's success (parents, employers, organizations, etc.) also suffer when an individual with whom they are connected make a social media error. In the case of parents, these errors can cause trauma as they see the positive benefits of years of education and training evaporate in an instant because of a moment of indiscretion.

Similarly, employers and organizations have vested interest in ensuring that social media posts made by individual employees and members do not have a detrimental impact on the collective.

There have been prior attempts at controlling social networking. The Nadler US patent application publication No. 2009/0217342 discloses a system for parental control of social networking in which pre-set rules are established to restrict certain types of social media interaction and communication. The Strutton et al US patent application No. 2011/0213670 discloses method and system for creating and inserting application media content in to social media system displays. A moderator can oversee messages and responses to address or delete defamatory or abusive messages from the system.

While the prior methods and systems are satisfactory, they do not allow the user the opportunity to appoint a group of individuals having different perspectives to oversee proposed social media messages and provide feedback to the user as to the appropriateness of the messages before they are distributed. The present invention was developed in order to overcome these and other drawbacks of the prior methods and systems by providing a risk management method to pre-screen messages prior to transmission.

### SUMMARY OF THE INVENTION

Friends, family, employers, and public relations managers now have a tool to help monitor, approve and adjust posts and tweets of individuals whom they manage, be it as a parent/guardian, client or employee. Further, users are able to delegate posting responsibility to tertiary entities. This risk management tool serves as a moderator of posts, tweets, and blogs and helps mitigate backlash or other undesired results of unfiltered social commentary.

The method according to the invention offers a way to protect a loved one, friend, colleague, or client from social media missteps and their lifelong implications among all social media management applications.

The method also allows users to delegate day to day posting duties to outside individuals without releasing authentication credentials to the appointed posting delegate.

### BRIEF DESCRIPTION OF THE FIGURES

FIG. 1 is a graphical representation of the effectiveness of various approaches to social media protection;

FIG. 2 is a table showing example schedules for adding functionality to a social media collaborative moderation posting method according to the invention; and

FIG. 3 is a flow chart of the four primary steps according to the social media collaborative moderation posting method according to the invention.

### DETAILED DESCRIPTION

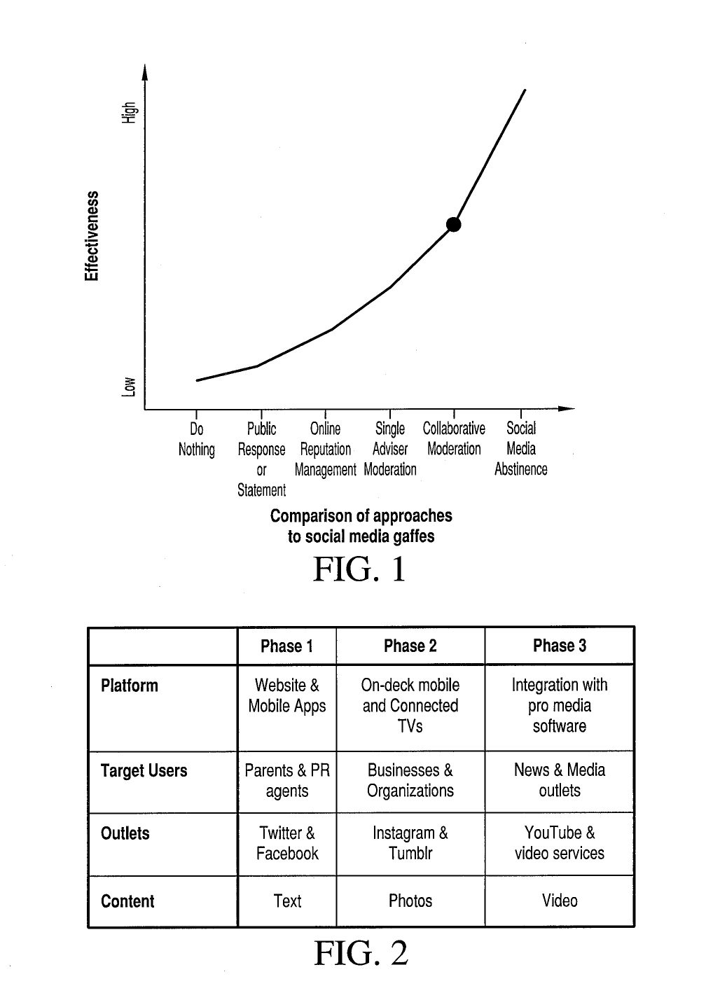

Referring first to FIG. 1, the invention will be described with reference to the effectiveness, plotted on the Y-axis, of various approaches to management of social media gaffes which are plotted on the X-axis.

The first X-axis indicator of FIG. 1 is Do Nothing. That is, the response to a social media gaffe is to “do nothing”, thus enacting a passive, laissez-faire approach. Such an approach has minimal effectiveness in preventing further mistakes in social media transmissions or posts.

The second X-axis indicator of FIG. 1 is Public Response or Statement. A public response is a statement released for public consumption, either by the poster him or herself or by the poster's designated representative such as a public relations representative, agent or manger. The statement directly or indirectly addresses a post or clarifies the intent of the post. Public statements are often referred to as spin control. They are slightly more effective than the laissez-faire do nothing approach.

The third X-axis indicator of FIG. 1 is Online Reputation Management (ORM) which is the practice of monitoring and mitigating text, photo and video posts in web, mobile and online media content. ORM primarily involves tracking what is written about a client using online and offline techniques to promote positive content and remove negative content or relegate it to positions of lesser prominence. This approach is marginally more effective than a Public Response or Statement.

The fourth X-axis indicator of FIG. 1 is Single Adviser Moderation. Single Adviser Moderation is the practice of obtaining the opinion of an individual adviser before posting to a social media outlet. This allows the user to gain a valuable third-party perspective before releasing information to the public. This practice is more effective than Online Reputation Management because it involves objective and subjective analysis of a social media post before it is posted, thereby reducing the likelihood that the post could later prove to be embarrassing or harmful to the poster or his or her reputation.

The fifth X-axis indicator of FIG. 1 is Collaborative Moderation in accordance with the present invention. Collaborative Moderation is the practice of obtaining the opinions of a panel of advisers before posting to a social media outlet. This allows the user to not only gain valuable third-party perspectives before releasing information to the public, but also allows the user to benefit from multiple perspectives and experience bases. It is more effective than Single Adviser Moderation because a plurality of viewpoints and opinions are obtained prior to posting.

The sixth X-axis indicator of FIG. 1 is Social Media Abstinence. Social Media Abstinence is essentially refraining from posting to social media, either temporarily or permanently. While this approach ensures that a user will not make any social media gaffes, it also ensures that he or she will also not receive any positive benefits from participation in social media.

FIG. 2 is a table showing the various phases for implementing a social media collaborative moderation method according to the invention.

In phase 1, the platform for implementing the method will include websites and mobile applications (apps). Generally, communication is via the Internet so that anyone with Internet access can register with the collaborative moderation service according to the invention. Those with smart phones or tablets can download a mobile application which facilitates registration and communication. The target users are parents and public relations agents for the user or poster. The outlets include TWITTER and FACEBOOK social media and the content is primarily text. In phase 2, the platform is expanded to include on-deck mobile communication devices and connected televisions. The target users are businesses and organizations, as opposed to individuals. The outlets are INSTAGRAM and TUMBLR and the content includes photographs. In phase 3, the platform provides integration with professional media and software and the target users are news and media organizations. The outlets include YOUTUBE and other video services and the content is video. The phases set forth in FIG. 2 are by way of example only and it will be appreciated by those of ordinary skill in the art that other implementations of the inventive method are available.

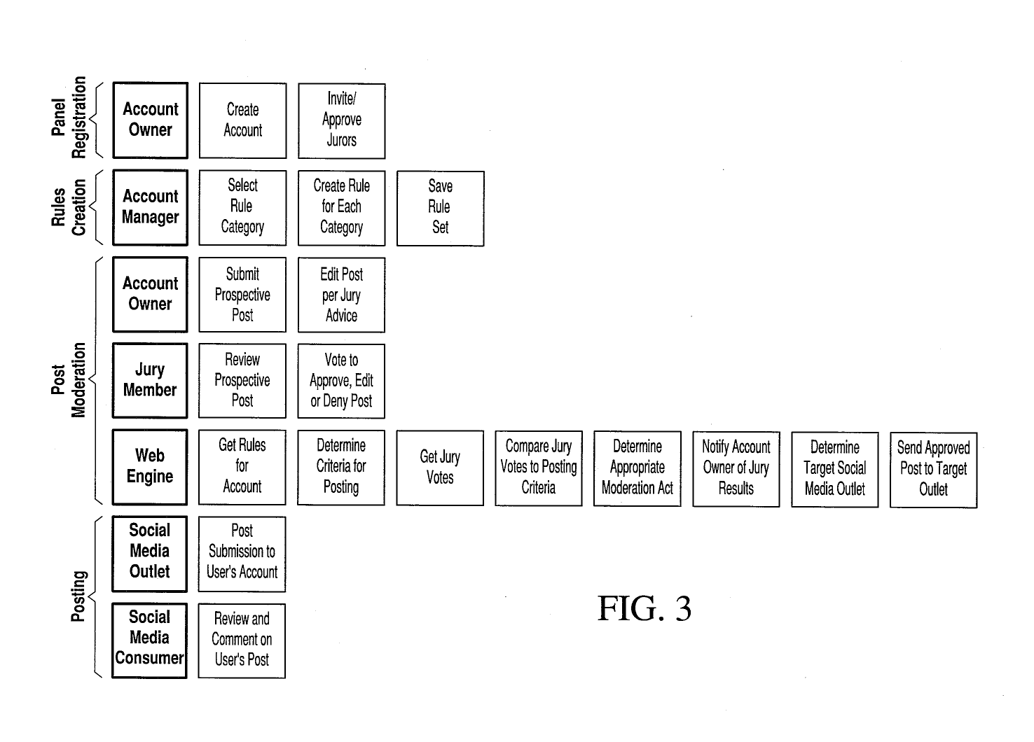

FIG. 3 is a flow chart illustrating the preferred embodiment the social media collaboration moderation method according to the invention. In its broadest terms, the inventive method includes a process for registration of a panel or jury that will be collaboratively moderating posts and tweets of a user and a process for reviewing, suggesting edits to and approving social media posts from the user including criteria that must be met before content can be posted.

The first step is identified as Jury Registration. The user or poster identifies or selects individuals whose opinions can be trusted enough to permit them to approve or deny the user's social media posts. The selected individuals for a jury, whose members may include parents, friends, colleagues, agents, lawyers, managers, coaches, administrators, and the like or any combination of the above. For effectiveness, a jury of four to six individuals is preferred, but any number of individuals may be included in the jury.

The second step according to the inventive method shown in FIG. 3 is Rules Creation in which the rules that will determine whether a post intended for a social media outlet will be allowed to be posted, recommended for editing, or rejected are defined. By way of example, the rules may include a minimum number or percentage of jurors responding positively for approval of a post, a time limit for the required number of jurors to respond to a post, and whether a post automatically posted or rejected if the jury has not responded within the allotted time.

The third step according to the inventive method is Post Moderation. This relates to the process of judgment of a post by individual members of the jury and the collective decision to post, revise or reject a post based on the collective judgment and the rules established for the user's account.

The fourth step according to the method is Posting which is the simple process of sending a social media post to the desired social network outlet in accordance with the user's credentials for the chosen outlets. The collaborative moderation provided by method according to the invention is invisible to the readers of the final post, unless an indicator is chosen by the account owner or determined by his or her account type.

The data and information elements for the various steps shown in FIG. 3 will now be described. For jury registration, an account is created in a web-server which includes a processor and a system memory. The account includes the user's name, e-mail address, and username. The user establishes a plurality of social media user names, each having its own password. For each individual invited and approved by the user to serve on the user's jury,

The name, e-mail address and social media outlet ID (i.e. Twitter name) of the juror is provided. Each user or jury member can be a member of a plurality of groups, with each group having its own set of rules as established by the originator of the group. The user or jury member has the option to accept or decline participation within each group.

The web server includes a plurality of rules options which are selected by the user. These include the minimum number of minimum percentage of jurors who must respond positively before a post is released for posting, whether a specific juror is required to respond before a post is accepted or rejected, the time period required to receive a response from the jurors before a post is accepted or rejected, and the location of prospective posts.

In operation, the user submits a prospective post which is transmitted to the user's jurors by the web-server via a secure, encrypted data transfer. The post can be in the form of text, an image, or a video. The jurors review the prospective post and respond as soon as possible with their approval or disapproval. If desired, the jurors can also be given the option of suggesting that the post be modified in some fashion. The web-server analyzes the juror responses in accordance with the rules pre-established by the user. If the required logical truth values and number of approvals are obtained within the time period for response established by the account administrator, the post is released for distribution. If insufficient approvals are obtained or an insufficient number of responses are not obtained within the time period, the post is rejected and not released.

Many features may be incorporated into the collaborative moderation of social media posts and tweets according to the invention. For example, the user may designate a third party to initiate a post on the user's behalf. In such a situation, the third party, who is not a juror, is subject to the rules established by the user. However, the user may have the authority to veto a proposed post from the third party. In addition, the ultimate owner of an account may establish an incremental set of rules which take effect in the event of the occurrence of a predetermined condition, such as a time of crisis, a financial blackout period, or other instance where different rules must be enforced. The ultimate owner may also institute an embargo on all further social media posts or tweets in response to the occurrence of such a condition. The embargo may be for a set period of time or until the embargo is ended by the ultimate owner.

It will be apparent that the method is of particular benefit to celebrities who wish to communicate with his or her followers with current messages and opinions about ongoing events. The celebrity can select a cross-section of trusted individuals to serve on his or her jury. For example, the celebrity's parents, siblings, agent, public relations representatives or other individuals can be selected as jurors. Collectively, the jurors act as a filter to insure that inappropriate statements are not released via social media. One particular benefit of the collaborative moderation method according to the invention is that it is performed in a real-time environment providing the immediacy that social media and online communications currently require.

The method is also appropriate for businesses or other entities who participate in social media. The ability for the user to select its jury and its rules will govern the degree of care, scrutiny and selectivity which is applied to a prospective post before it is released.

While the preferred forms and embodiments of the invention have been illustrated and described, it will be apparent to those of ordinary skill in the art that various changes and modifications may be made without deviating from the inventive concepts set forth above.

What is claimed is:

1. A method for the collaborative moderation of social media posts and tweets of a user via a web-server including a processor and a system memory, comprising the steps of
(a) transmitting a prospective social media post from the web-server to a plurality of preselected individuals, respectively;
(b) receiving responses to the prospective social media post from the preselected individuals; and
(c) analyzing the responses in accordance with rules established by the user to determine whether the post is to be released by the web-server for posting to a social network.

2. A method as defined in claim 1, wherein the posts and the responses are transmitted via an electronic communication network.

3. A method as defined in claim 2, and further comprising the step of downloading one of a web browser and mobile application to an electronic communication device for each preselected individual which is used by the individual to receive and respond to the prospective post.

4. A method as defined in claim 2, wherein said rules include at least one of receiving a response from a minimum number of individuals, receiving the responses within a given time period, and receiving a response from a particular individual.

5. A method as defined in claim 4, and further comprising the step of indicating to the user when a prospective post is not released and the at least one rule which prevented the post from being released.

6. A method as defined in claim 5, and further comprising the step of establishing a user profile on the web-server.

7. A method as defined in claim 6, and further comprising the step of establishing a plurality of user profiles for a plurality of social media networks, respectively.

8. A method as defined in claim 7, wherein said proposed post further includes a social media network destination.

9. A method as defined in claim 4, and further comprising the step of designating a third party to initiate a post on behalf of the user, the third party being subject to said rules.

10. A method as defined in claim 9, wherein the user has the right to veto a post from said third party irrespective of said rules.

11. A method as defined in claim 1, and further comprising the step of automatically enabling an incremental set of rules in response to a predetermined condition.

12. A method as defined in claim 1, and further comprising the step of implementing an embargo on all social media posts and tweets.
